(19) United States
(12) Patent Application Publication
(10) Pub. No.: US 2025/0137092 A1
(43) Pub. Date: May 1, 2025

(54) BLANKING AGENT FOR PRECIOUS METAL RECOVERY IN REFRACTORY MATERIALS

(71) Applicant: Nevada Gold Mines LLC, Elko, NV (US)

(72) Inventors: John William Langhans, JR., Spring Creek, NV (US); Jack Stuart McPartland, Sparks, NV (US); Cristian Dragusanu, Toronto (CA)

(21) Appl. No.: 18/935,173

(22) Filed: Nov. 1, 2024

Related U.S. Application Data
(60) Provisional application No. 63/595,214, filed on Nov. 1, 2023.
(60) Provisional application No. 63/684,767, filed on Aug. 19, 2024.

(51) Int. Cl. C22B 11/08; C22B 3/06

(52) U.S. Cl. CPC C22B 11/08; C22B 3/06

(57) ABSTRACT

The present disclosure is directed to a process that leaches a precious metal from a precious metal-containing material comprising carbonaceous matter in the presence of a blanking agent comprising one or more of a methylphenol and phenolate salt thereof to form a pregnant leach solution comprising the precious metal followed by precious metal recovery from the pregnant leach solution.

### CROSS-REFERENCE TO RELATED APPLICATIONS

The present application claims the benefit of U.S. Provisional Application Ser. Nos. 63/595,214 filed Nov. 1, 2023, and 63/684,767, filed Aug. 19, 2024. The entire disclosure of the application listed is hereby incorporated by reference, in its entirety, for all that the disclosure teaches and for all purposes.

### FIELD

The disclosure relates generally to precious metal recovery and particularly to a blanking or blinding agent for gold recovery in carbonaceous materials.

### BACKGROUND

The principal technology used to recover precious metals is cyanide leaching, in which gold is leached from the ore by treatment with a solution of cyanide. For lower grade ores, run of mine (ROM) dump leach only simply excavates the ore and places the excavated ore onto the heap or dump leaching pad. For higher grade and refractory (sulfide) ores, the first step is comminution (grinding) to increase surface area and expose the gold to the extracting solution. The extraction is conducted by dump or heap leaching processes using sodium cyanide. The crude ore is washed with a solution of cyanide in air, often repeatedly, and the aqueous extract is collected and refined further. Recovery from the pregnant leach solution typically involves adsorption on activated carbon in a carbon in pulp or carbon in column (CIC) process.

A “refractory” gold ore is an ore that has ultra-fine gold particles disseminated throughout its gold occluded minerals. These ores are naturally resistant to recovery by standard cyanidation and carbon adsorption processes. These refractory ores require pre-treatment for cyanidation to be effective in recovery of the gold. A refractory ore generally contains sulfide minerals, preg-robbing carbon or both. Sulfide minerals are impermeable minerals that occlude gold particles, making it difficult for the leach solution to form a complex with the gold. Preg-robbing carbon present in gold ore may adsorb dissolved gold-cyanide complexes in much the same way as activated carbon. This so-called “preg-robbing” carbon is typically lost because it is significantly finer than the carbon recovery screens typically used to recover activated carbon.

Carbonaceous matter or preg-robbing carbon can therefore directly or indirectly interfere with lixiviation. Direct interference with lixiviation is generally due to either occlusion of the gold within the carbonaceous material or formation of a stable gold-carbon complex similar to a chelate. The more common problem with these ores, however, is indirect interference due to preg-robbing carbon preventing dissolved gold from being available for recovery from solution.

Certain clay materials such as smectite, montmorillonite, illite, and kaolinite are also known to preg-robbingly adsorb the gold-cyanide complex. Thus, the degree of preg-robbing exhibited by an ore depends on the amount of carbonaceous matter and preg-robbing clay materials in the ore. Depending on the application, the carbonaceous component and carbonaceous matter can include preg-robbing clays, because the preg-robbing properties of these materials are functionally similar to that of the actual carbonaceous matter in the ore.

While preg-robbing is most frequently associated with cyanidation processes, the preg-robbing phenomenon is also known to occur with other gold-lixiviant complexes such as gold-chloride. Preg-robbing of gold-thiourea complexes has even been documented when using a thiourea lixiviant.

Treatments of carbonaceous ores with chemical surfactants as blinding agents to limit preg-robbing have shown promising results. The blinding or “blanking” of the preg-robbing carbon are selectively adsorbed by and passivate the exposed surface of the preg-robbing carbon until it is saturated and unable to adsorb the gold-lixiviant complexes in solution. Diesel oils, kerosene, fuel oil, natural oils, cationic, and anionic surfactants and RV-2 (para nitro benzol azo salicyclic acid) have been used as blinding agents with varying degrees of success.

Other pre-treatment options for refractory ores include roasting, bio-oxidation (e.g., bacterial oxidation), and pressure oxidation. The refractory ore treatment processes may be preceded by concentration (usually sulfide flotation). Roasting is used to oxidize both the sulfur and preg-robbing carbon at high temperatures using air and/or oxygen. Bio-oxidation involves the use of bacteria that promote oxidation reactions in an aqueous environment. Pressure oxidation is an aqueous process for sulfur removal carried out in a continuous autoclave, operating at high pressures and somewhat elevated temperatures.

### SUMMARY

These and other needs are addressed by the various embodiments and configurations of the present disclosure.

In an embodiment, a process can include the steps:

leaching a precious metal from a precious metal-containing material comprising a preg-robbing material in the presence of a blanking agent comprising one or more of a methylphenol and phenolate salt thereof to form a pregnant leach solution comprising the precious metal; and
recovering at least most of the precious metal from the pregnant leach solution.

In an embodiment, a process can include the steps:

leaching a precious metal from a precious metal-containing material comprising a preg-robbing material in the presence of a blanking agent to form a pregnant leach solution comprising the precious metal, wherein the blanking agent comprises 2-isopropyl-5-methylphenol and wherein the leaching comprises contacting a cyanide-containing lixiviant with the precious metal-containing material; and
recovering at least most of the precious metal from the pregnant leach solution, wherein a preg-rob factor of the preg-robbing material in the presence of the blanking agent was no more than about 75% of a preg-rob factor of the preg-robbing material in the absence of the blanking agent.

In an embodiment, a process can include the steps of:

mixing a blanking agent with a caustic solution to form a reagent-containing solution, the blanking agent comprising one or more of a methylphenol and phenolate salt thereof;
leaching a precious metal from a slurried precious metal-containing material comprising a preg-robbing material in the presence of the reagent-containing solution to form a pregnant leach solution comprising the precious metal, wherein a concentration of the slurried precious metal-containing material in the slurry ranges from about 15 to about 50% solids, and wherein the slurry comprises a cyanide-containing lixiviant; and
recovering at least most of the precious metal from the pregnant leach solution.

The present disclosure can provide a number of advantages depending on the particular configuration.

The blinding or blanking agents of the present disclosure can have a number of advantages compared to conventional blinding agents. Methylphenols, particularly methylphenols in the form of 2-isopropyl-5-methylphenol or thymol and carvacrol, can be much more effective than diesel and fuel oils and kerosene, requiring much lower concentrations to be added, thereby limiting blinding agent carryover to activated carbon in carbon-in-leach (CIL) circuits. Methylphenols can be stable in heap leaching applications and capable of blinding or blanking preg-robbing carbon from preg-robbing gold from the pregnant leach solution. Methylphenols can be environmentally benign. Thymol and carvacrol in particular have been found by the U.S. Environmental Protection Agency to have minimum potential toxicity and pose nominal risk to the environment.

These and other advantages will be apparent from the disclosure contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “methylphenol” refers to a family of organic compounds comprising an aromatic compound derived from phenol, that can exist in isomeric forms. Examples include ortho-Cresol (2-methylphenol, also known as 2-hydroxytoluene or ortho-Toluenol, meta-cresol, and para-cresol all having the formula CH3C6H4(OH)), thymol (2-isopropyl-5-methylphenol having the formula C₁₀H₁₄O, which is a natural monoterpenoid phenol derivative of p-cymene), and carvacrol (having the formula C₆H₃(CH₃)(OH)C₃H₇, (which is isomeric with thymol)). Thymol in particular is produced by the alkylation of m-cresol and propene.

“Precious metal” refers to gold, silver, and the platinum group metals (e.g., ruthenium, rhodium, palladium, osmium, indium, and platinum.

“Preg-robbing carbon” refers to “Total Carbonaceous Matter” or “TCM” and Disseminated Carbonaceous Matter” or “DCM”. TCM particles commonly consist of almost 100% carbon. DCM particles are disseminated in minerals, such as quartz or other gangue minerals with different degrees of finely disseminated carbonaceous matter. The distribution of the carbonaceous material on these grains is discontinuous and shows very high variability from grain to grain or from ore to ore. In some ores, the preg-robbing carbon includes one or more of (1) an activated carbon component capable of adsorbing gold-chloride complexes and gold-cyanide complexes from solution, (2) a mixture of high molecular weight hydrocarbons usually associated with the activated carbon components; (3) an organic acid, similar to humic acid containing functional groups capable of interacting with gold complexes to form organic gold compounds; and (4) graphitic carbon.

“Preg-robbing material” refers to preg-robbing carbon and other substances, such as clay materials (e.g., smectite, montmorillonite, illite, montmorillonite, and kaolinite that preg-robbingly adsorb the precious metal complex (such as the gold-cyanide complex) from a pregnant leach solution.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawing is incorporated into and forms a part of the specification to illustrate several examples of the present disclosure. This drawing, together with the description, explain the principles of the disclosure. The drawing simply illustrates preferred and alternative examples of how the disclosure can be made and used and are not to be construed as limiting the disclosure to only the illustrated and described examples. Further features and advantages will become apparent from the following, more detailed, description of the various embodiments of the disclosure, as illustrated by the drawings referenced below.

FIG. 1 is a flow schematic of various processes according to the present disclosure.

FIG. 2 is a plot of preg-rob factor (% Au) (vertical axis) against thymol:TCM mass ratio (horizontal axis);

FIG. 3 is a bar graph of preg-rob factors (% Au) before and after thymol pre-treatment (vertical axis) against sample identifier (horizontal axis);

FIG. 4 is a plot of preg-rob factor (% Au) (vertical axis) against thymol:TCM mass ratio (horizontal axis);

FIG. 5 is a plot of preg-rob factor (% Au) (vertical axis) against thymol:TCM mass ratio (horizontal axis);

FIG. 6 is a plot of preg-rob factor (% Au) (vertical axis) against thymol:TCM mass ratio (horizontal axis);

FIG. 7 is a plot of preg-rob factor (% Au) (vertical axis) against thymol:TCM mass ratio (horizontal axis);

FIG. 8 is a plot of preg-rob factor (% Au) (vertical axis) against thymol:TCM mass ratio (horizontal axis);

FIG. 9 is a plot of preg-rob factor (% Au) (vertical axis) against thymol:TCM mass ratio (horizontal axis);

FIG. 10 is a plot of preg-rob factor (% Au) (vertical axis) against thymol:TCM mass ratio (horizontal axis);

FIG. 11 is a plot of preg-rob factor (% Au) (vertical axis) against thymol:TCM mass ratio (horizontal axis); and

FIG. 12 is a plot of preg-rob factor (% Au) (vertical axis) against thymol:TCM mass ratio (horizontal axis).

### DETAILED DESCRIPTION

In accordance with embodiments of this disclosure, a process for recovering a precious metal from mineralized material containing preg-robbing material can include the steps of:

leaching a precious metal from a precious metal-containing material comprising carbonaceous matter in the presence of a blanking agent comprising one or more of a methylphenol and phenolate salt thereof to form a pregnant leach solution comprising the precious metal; and
recovering at least most of the precious metal from the pregnant leach solution.

The blanking agent can include 2-isopropyl-5-methylphenol, carvacrol, or a phenolate salt thereof.

The blanking agent can have a concentration in the leaching step ranging from about 0.1 to about 25 g/L. The blanking agent can be added during leaching or in a preconditioning step of the precious metal-containing material before leaching.

The lixiviant can be any precious metal lixiviant, with cyanide being exemplary.

The recovering step can be done by any suitable process for removing dissolved precious metal from the pregnant leach solution, with adsorption of the precious metal onto activated carbon in one or more of a carbon-in-leach (CIL) and carbon-in-pulp (CIP) process being illustrative.

The precious metal in the precious metal-containing material typically comprises gold.

The present disclosure is directed to the use of methylphenols and phenolate salts thereof as blinding or blanking agents in recovering precious metals, particularly gold, from refractory and double refractory materials containing a preg-robbing material. Methylphenols, particularly methylphenols in the form of 2-isopropyl-5-methylphenol or thymol and carvacrol, can be used in low enough concentrations that blinding agent carryover to activated carbon in carbon-in-leach (CIL) or carbon-in-pulp (CIP) or carbon-in-column (“CIC”) circuits is expected to be limited. Methylphenols can be stable in heap leaching applications and capable of blinding or blanking preg-robbing carbon from preg-robbing gold from the pregnant leach solution. While methylphenols are noted in the literature as being most stable in acidic conditions, they have surprisingly and unexpectedly been found to be stable in highly alkaline conditions.

The blanking agent can be used with any precious metal lixiviant including without limitation sodium or ammonia cyanide, thiosulfate, thiourea, polysulfide, lime sulfur, halogens and compounds thereof (e.g., halides, ferric chloride), alkaline amino acid, thiocyanate, ammonia, nitriles, sulfuric acid, chlorine, hydrogen peroxide, nitric acid, aqua regia, and mixtures thereof. The lixiviant can have an acidic, neutral, or basic pH.

In some applications, methylphenols can be added to the precious metal-containing material in pretreatment processes prior to or during sulfide oxidation or carbonaceous material neutralization, such as oxidation pretreatment processes involving acidic solutions, and carried over through neutralization and other intermediate processing steps into alkaline leaching using cyanide. For example, methylphenols can be added in or prior to prior sulfuric acid leaching or oxidation operations to blind the preg-robbing carbon before acid neutralization. Methylphenols can be added during comminution (e.g., wet crushing and/or grinding and/or milling) to react with the newly exposed surfaces of the preg-robbing carbon. There would be an additional benefit to add methylphenols in the grinding mill where process water containing residual cyanide is often used (and preg-robbing takes place). Some methyphenols, particularly methylphenol salts such as a metal (Na, K, Li, Cu, and Zn) and ammonium (tetrabutylammonium and choline) phenolate salts of thymol, can be thermally stable under pressure oxidation operating conditions.

In some applications, methylphenols can be added to the leach solution after bio-leaching of sulfidic minerals to blind preg-robbing carbon for subsequent precious metal recovery leaching while killing the bioleaching microbes remaining after biooxidation of sulfides. This approach is applicable in an alkaline oxidation environment as well, though the biocide activity may not be as effective as in the acidic environment. pH control can be important in such applications. When bio-leaching is employed at low pH, methylphenols can act as a biocide that can inhibit bioleaching reaction kinetics.

While the blinding agent can be contacted with the slurried precious metal-containing material in any form, whether as a solid or liquid, it is typically in the form of a solid that is dissolved in a solvent to form a liquid mixture that is then contacted with the slurried precious metal-containing material. The solvent pH can be basic or acidic or neutral depending on the application. In some applications, the blinding agent is in the form of a crystalline or semi-crystalline material and is dissolved in a caustic solution before contact with the precious metal-containing material.

In some applications, the methylphenols can be mixed with or dissolved in a caustic solution to form a reagent-containing solution, which is then contacted with the leach solution. While not wishing to be bound by any theory, it is believed that premixing the methylphenol with a caustic solution can substantially maximize preg-rob mitigation while stabilizing TCM blanking performance and substantially minimize the sensitivity of the process to variations in pH or the method used for pH control. In some applications, leaching performed at natural pH can produce similar results to leaching performed with pH adjustment using lime or other bases. As will be appreciated, any caustic agent may be employed, including sodium hydroxide, potassium hydroxide, calcium oxide, and the like. The concentration of caustic agent in the caustic solution typically ranges from about 0.1 g/L to about 50%, more typically ranges from about 0.5 g/L to about 25 g/L, more typically ranges from about 1 g/L to about 10 g/L, and even more typically ranges from about 1 g/L to about 7.5 g/L.

Current work has shown, for a thymol concentration of 10 gpL, partial solubility observed beginning at about 1 gpL NaOH, with total solubility at about 4 gpL NaOH. The caustic solution typically comprises from about 1 to about 10 g/L caustic soda or sodium hydroxide. It is expected that higher thymol concentrations (which could be required for high carbon-containing ores/metallurgical products) may require higher NaOH concentrations, such as a NaOH concentration typically of at least about 15 g/L, more typically of about 20 g/L, and more typically of about 25 g/L.

The amount of blanking agent used can depend on the application, including the TCM content of the precious metal-containing material. In some applications, the weight or mass ratio of blanking agent to the preg-robbing material or TCM ranges from about 0.001:1 to about 10:1 and more typically ranges from about 0.5:1 to about 1:1. The concentration of methylphenols in the liquid component contacted with the precious metal-containing material and/or in the slurry containing the precious metal-containing material typically ranges from about 0.1 to about 25 g/L, more typically from about 0.25 to about 15 g/L, and even more typically from about 0.5 to about 10 g/L.

The preg-rob factor of the preg-robbing material in the presence of the blanking agent can be reduced significantly when compared to the preg-rob factor of the preg-robbing material in the absence of the blanking agent. For example, the preg-rob factor of the preg-robbing material in the presence of the blanking agent can be no more than about 75% of a preg-rob factor of the preg-robbing material in the absence of the blanking agent, more typically no more than about 50% of a preg-rob factor of the preg-robbing material in the absence of the blanking agent, and even more typically no more than about 35% of a preg-rob factor of the preg-robbing material in the absence of the blanking agent. By way of illustration, the preg-rob factor of the preg-robbing material in the absence of the blanking agent can be typically more than 55%, more typically more than about 60%, and even more typically more than about 75% while the preg-rob factor of the preg-robbing material in the presence of the blanking agent can be no more than about 50%, more typically no more than about 40% and even more typically no more than about 30%.

The blinding agents can be used in gold leaching operations following roasting or chemical oxidation to blind or blank any preg-robbing carbon remaining after pretreatment. Roasting simultaneously destroys carbonaceous matter and oxidizes the sulfide minerals, in refractory carbonaceous gold ores. Chemical oxidation treats refractory gold ores through methods, such as chlorine oxidation or autoclave leaching. In chlorine oxidation, the ore is ground and mixed with water to form a slurry. Chlorine gas is pumped into the slurry under pressure at a rate of about 60 to 120 lbs/ton, depending on the residence time, preg-robbing carbon concentration in the ore, and percent solids in the slurry. The chlorine gas will oxidize the carbon in the ore, rendering it less preg-robbing. After treatment, the hypochlorous acid generated must be treated with a reducing agent to prevent it from destroying the cyanide used later in the process. Pressure oxidation is more successful at oxidizing sulfidic materials that make the ore refractory than at oxidizing carbonaceous matter that may be present under typical operating conditions.

The blinding agent can be used in gold leaching operations following bioleaching. Bioleaching uses bacteria to biologically degrade sulfide minerals and liberate precious metal values so that they can be recovered by conventional technologies. The most widely used and studied bacteria for this process is Thiobacillus ferrooxidans. Bioleaching, however, generally has little effect on the preg-robbing characteristics of an ore. Therefore, carbon-in-leach or blanking has been used in addition to bioleaching to obtain satisfactory gold yields from carbonaceous ores.

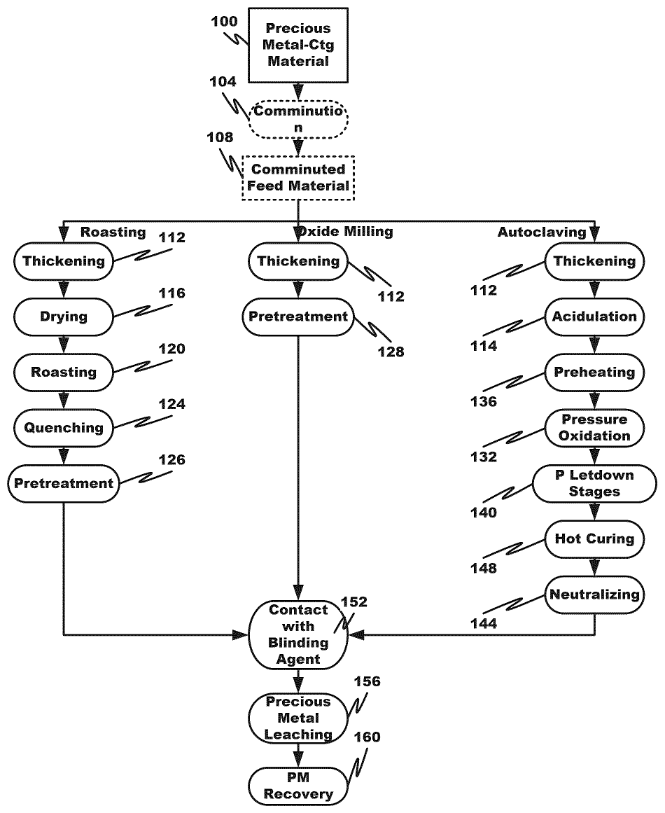

FIG. 1 depicts the use of the blinding agents of the present disclosure with several of these pretreatment processes, namely roasting, oxide leaching, and pressure oxidation.

With reference to FIG. 1, the precious metal-containing material 100 can be in the form of a sulfidic or oxidized precious metal-containing material.

The sulfidic precious metal-containing material comprises from about 1 to about 100 g/tonne gold, from about 2 to about 60 wt. % sulfides, and from about 0.05 to about 10 wt. % preg-robbing carbon. Commonly, the sulfide minerals are predominantly pyrite, realgar, orpiment, chalcopyrite and arsenopyrite, with minor amounts of enargite, pyrrhotite, sphalerite, galena, stibnite, cinnabar, covellite, chalcocite and other commonly occurring sulfide minerals. The precious metal-containing material can be in any form, such as a flotation concentrate, raw ore, flotation tailings, and the like.

The oxidized precious metal-containing material can be oxidized by environmental exposure in which other metallic elements and sulfides are gradually leached away, leaving behind gold and insoluble oxide minerals as surface deposits. Typically, it comprises from about 1 to about 100 g/tonne gold, no more than about 5 wt. % sulfides, from about 2 to about 60 wt. % oxide minerals, and from about 0.05 to about 10 wt. % preg-robbing carbon or residual carbonaceous matter. Commonly, the sulphide minerals are predominantly pyrite, realgar, orpiment, chalcopyrite and arsenopyrite, with minor amounts of enargite, pyrrhotite, sphalerite, galena, stibnite, cinnabar, covellite, chalcocite and other commonly occurring sulphide minerals. The precious metal-containing material can be in any form, such as a flotation concentrate, raw ore, flotation tailings, and the like.

The precious metal-containing material 100 in step 104 is comminuted, such as by wet or dry crushing or grinding to a desired size range. The comminution circuit typically includes the steps of crushing/grinding in comminution step 104, and thickening 112 to produce a comminuted precious metal-containing material 108, that is typically from about 30 to about 60 wt. % solids. The overflow from the thickening circuit 112 (which is primarily water) is recycled back to the grinding step for reuse. Additional water is added to the grinding device (which is typically a Semi-Autogeneous or SAG, ball mill, high pressure grinding roll or HPGR, or rod mill, or combination of thereof) as needed to provide the desired liquid fraction to the slurry outputted by the grinding step. As will be appreciated, there are a large number of other comminution circuit designs and/or components that can be used in the process. The size range depends on the particular process to be employed. Typically for non-heap leaching applications, the comminuted feed material 108 has a P₈₀ size ranging from about 600 to about 100 mesh (Tyler) and for heap leaching applications, the comminuted feed material, before agglomeration, has a P₈₀ size ranging from about 10 mesh (Tyler) to about 5 inches.

As noted, the blinding agent can be added during communication 104 and/or thickening 112 depending on the stability of the blinding agent in subsequent process steps.

When roasting is the subsequent process and the precious metal-containing material is sulfidic precious metal-containing material, the thickened comminuted feed material is dried 116, roasted 120, and the calcine quenched 124. Modern roasters use a fluidized bed construction and conventional fuel source to heat the ores at start-up. Roasters are typically autogenous and use the fuel energy within the ore itself to maintain operating temperatures. Conventional fuel sources such as propane or natural gas are generally used upon start-up as a pre-heat step until the bed ignites. Roasting temperatures are usually between about 500° and 700° C. After roasting, the calcine is separated from dust and off-gasses and then quenched.

For any particular ore composition, roasting plants operate in a narrow range of tolerances. Below optimum temperature the carbon in the ore is not oxidized and remains actively preg-robbing. Above the optimum temperature, the gold in the ore becomes increasingly less amenable to cyanidation or other extraction techniques. Because of the degrading gold recovery with higher temperatures, many roasters are operated toward the lower side of the range. The blanking agent is added to passivate any unroasted carbonaceous matter. Accordingly, roaster efficiency in a plant environment tends to vary widely with variation in feed stock and operating conditions.

Following quenching, the oxidized ore or calcine can be pretreated 126 and processed using traditional cyanide extraction techniques. Pretreatment 126 typically comprises forming the calcine into a slurry and pH adjusting the slurry with acid consumers to about pH 10.5.

When oxide milling is the subsequent process and the precious metal-containing material is oxidized precious metal-containing material, thickening 112 and pretreatment 128 are performed before precious metal leaching. The slurried precious metal-containing material is adjusted by adding water and acid consumers, such as carbonate containing flotation tailing, limestone and lime. The pH value of the slurry is adjusted to inhibit hydrogen hydrolysis in the process of cyanide treatment, neutralize the sulfuric acid, and carbonated acid produced in the process of cyanide, and avoid the action of H and cyanide to produce HCN (hydrogen cyanide). In addition, it can reduce the destruction effect of iron minerals on CN⁻ (cyanide ion). When slurry adjusting, it should be noted that the amount of acid consumers should be based on the amount of gold mine ore or concentrate. Generally, the liquid-solid weight ratio of the pulp is 2-4:1, which can ensure that the activated carbon is suspended in the pulp, so as to facilitate the subsequent adsorption operation. The equipment required in this stage is mainly one or more agitation tanks. The pre-cyanidation treatment of oxidized precious metal-containing slurry is in a stirred reactor, typically one or more pressure kettles, with the addition of sodium cyanide (reaction under the pressure of about 0.6 MPa˜1.0 MPa). The blanking or blinding agent can be added during pre-cyanidation treatment. The general cyanide pretreatment time is 0.5-2 hours to ensure that the pre-cyanide and blanking reactions are fully conducted. The stirred tank reactor stirring speed is in the range of about 600-1200 r/min, which can promote the diffusion of CN- and oxygen in the pulp and improve the pretreatment efficiency.

When pressure oxidation is the subsequent process and the precious metal-containing material is sulfidic precious metal-containing material, slurry from the comminution circuit, at approximately 35% solids and 80-85% passing 135 mm is pumped to one or more thickeners. Thickener underflow, at approximately 54% w/w solids, is pumped to a train of four acidulation tanks in acidulation step 114. Sulfuric acid is added to the slurry to destroy sufficient carbonate prior to entering the pressure oxidation circuit. Process air is also injected into the acidulation tanks to aid in carbon dioxide removal. Carbonate levels are typically reduced to <2% in the acidulation tanks.

The slurry is advanced from the acidulation tanks through a series of direct contact heater (“splash”) vessels in preheating step 136 before feeding into the autoclave. The slurry is preheated to a temperature of 165-175° C. as it passes through the splash vessels. The heat source in the splash vessels is the flashed steam, which is released from the slurry discharging from the autoclave as it passes through the pressure let down (“flash”) vessels. The slurry enters the splash vessels at the top and cascades down the internal baffles, while the flashed steam enters the lower section of the vessel and rises, contacting the slurry for direct heat transfer. The bottom of each vessel serves as a pump box for the interstage feed pumps. The discharge from the high-pressure splash vessel is pumped into the autoclave.

The preheated and pretreated material is introduced into the first compartment of the autoclave. The autoclave will typically have at least six compartments to minimize short circuiting of the feed slurry to the pressure oxidized slurry as can occur in autoclaves with fewer compartments. Short circuiting reduces the degree of completion of the pressure oxidation reactions. Excess gas, including components such as carbon dioxide, oxygen, nitrogen, and argon, is vented through a vent. As will be appreciated, the autoclave atmosphere typically contains at least about 80% steam, 10% molecular oxygen, and 10% inert gases. Each compartment includes one or more agitators and sparge tubes for introducing molecular oxygen. As will be appreciated, the autoclave can have any number of compartments and be of any suitable design, including a stacked or vertical autoclave design. Cooling water (not shown) can be added to the various compartments to maintain desired slurry temperatures. Preferably, no more than about 1% of the precious metal in the slurry is solubilized into the liquid phase of the pressure oxidized slurry during pressure oxidation.

The autoclave is preferably operated under conditions to promote hematite formation in the first one and/or two compartments of the multi-compartment autoclave. Desirably, hematite formation is promoted by maintaining the sulphuric acid concentration in the first compartment at a relatively low level. Once formed, hematite provides a favorable nucleation site for further hematite formation and suppresses formation and precipitation of basic iron sulphate and jarosite in downstream compartments of the autoclave. The average total residence time in the autoclave typically ranges from about 0.75 to about 2 hours.

The slurry discharges from the autoclave and passes through a series of pressure let down stages 140 called flash vessels. Pressure and temperature are gradually let down to atmospheric pressure and 96° C., after passing through the flash vessel circuit. The steam released by the instantaneous reduction in pressure through the flash vessel is ducted to the corresponding splash vessel. Slurry leaving the pressure let down circuit is then cooled from 96 to 48° C. by a series of six to eight shell and tube heat exchangers. The cooling water is on the shell side of the heat exchanger and the slurry passes through the tubes. In summary, the flash/splash system is a heat-recovery system, which minimizes the use of direct steam with inherent operating cost benefits.

After the slurry passes through the slurry coolers it is pumped to two parallel trains of neutralization tanks in neutralization 144, where the pH value is elevated from pH 1-2 to about pH 10.5. The neutralization step 144 can be performed in two stages. In the first stage, which can have multiple reactors, free flotation tailings or inexpensive limestone is contacted with the dissolved ferric sulphate and free sulfuric acid to form ferric hydroxide and gypsum. In a second stage to achieve a higher pH, typically at least about 90% of the dissolved ferric sulphate is precipitated. In the second stage which can also have multiple reactors, lime is contacted with the slurry discharged from the first stage of neutralization to reach the final pH.

In some configurations, a hot cure step 148 is used to convert the (solid) basic ferric sulphates in the discharged slurry to dissolved ferric sulphate. Preferably, the discharge slurry is held in the hot cure step 148 long enough for most of the basic ferric sulphates to be converted into the dissolved ferric sulphate. Dissolved ferric sulphate can be separated readily from the solid phase in a solid/liquid separation circuit. Moreover, the dissolved ferric sulphate in the separated liquid phase will be readily reacted with limestone during the subsequent neutralization to produce ferric hydroxide. Typically, the slurry 127 is held in the hot cure step 130 for a time ranging from about 1 to about 24 hours. The hot cure step 148 is preferably carried out in one or more stirred tank reactors at atmospheric pressure.

As noted, other processes can be used to oxidize the sulfidic precious metal-containing material. These techniques include chemical oxidation, such as using chlorine oxidation and oxidation using other oxidants, and bacterial leaching. In chemical oxidation using chlorine, the precious metal-containing material is ground and mixed with water to form a slurry. Bacterial leaching uses bacteria to biologically degrade sulfide minerals and liberate precious metal values so that they can be recovered by conventional technologies. The most widely used and studied bacteria for this process is Thiobacillus ferrooxidans. Chemical and bioleaching can be performed in a heap of particulates or in a continuous stirred tank reactor containing a slurry. The material may be agglomerated for heap leaching applications.

Suitable leaching techniques may also be utilized. In some embodiments, lower grade ores and other precious metal-containing materials are treated by run of mine (ROM) dump leaching techniques in which the material is excavated and placed onto the heap or dump leaching pad. In some embodiments, lower grade ores and other precious metal-containing materials are comminuted, optionally agglomerated, and heap or tank leached to oxidize sulfides. In either ROM dump or heap or tank leaching, the precious metal-containing residue is treated by precious metal leaching techniques noted above to dissolve and recover precious metals.

Regardless of the process employed, the oxidized precious metal-containing slurry is contacted with the blinding agent in step 152. As noted, the blinding agent may be added in any step of the process provided that it remains effective in downstream processing steps. The concentration of the blinding agent in the liquid component in contact with the precious metal-containing material and/or in the slurry containing the precious metal-containing material typically ranges from about 0.1 to about 25 g/L, more typically from about 0.25 to about 15 g/L, and even more typically from about 0.5 to about 10 g/L. The weight ratio of blinding agent to the carbonaceous material (e.g., TCM) typically ranges from about 0.001:1 to about 10:1, more typically from about 0.005:1 to about 5:1, and more typically from about 0.05:1 to about 2.5:1.

The precious metal is dissolved by leaching the oxidized precious metal-containing material in the pretreated/neutralized slurry in the precious metal leach step 156. The leaching agent or lixiviant is typically alkali-or acid-based, with exemplary lixiviants being cyanide, halides (iodide, bromide, chloride), ammonium, calcium, or sodium thiosulfate, and thiourea. In one configuration, the leach step is performed at atmospheric pressure and under alkaline conditions (at or above a pH of about pH 7) to produce a pregnant leach solution containing (at least) most of the precious metal content of the oxidized precious metal-containing material. The precious metal leach step 156 may be done by any suitable technique including using cyanide leaching and Carbon-in-Pulp or CIP techniques, Carbon-In-Leach or CIL techniques, cementation techniques, Resin-in-Pulp or RIP techniques, Resin-In-Leach or RIL techniques, or by circulating a pregnant leach solution and/or slurry through one or more gold sorbent columns. In the CIL, CIP, RIP, RIL, and other sorbent-based techniques, a sorbent, such as activated carbon or an ion exchange resin, sorbs the precious metal dissolved in the lixiviant. The blinding agent inhibits precious metal sorption on the preg-robbing carbon, but typically does not carry over to the target sorbent, thereby providing a high gold recovery. The sorbed precious metal is stripped from the sorbent in precious metal recovery step 160 by an acidic or alkaline eluant to form a barren sorbent for recycle to the leach step 156 with and/or without regeneration, and a pregnant eluate containing most of the precious metal sorbed on the sorbent.

In the precious metal recovery step 160, the precious metal is recovered from the pregnant leach solution (or pregnant eluate) by suitable techniques, such as electrowinning or cementation followed by smelting, to form a precious metal product. When required, the barren residue from the leaching step is subjected to cyanide detoxification or destruction and discarded as tailings.

The subject matter of this disclosure is further described in the attachments referenced below.

### EXPERIMENTAL

The following examples are provided to illustrate certain embodiments of the disclosure and are not to be construed as limitations on the disclosure, as set forth in the appended claims. All parts and percentages are by weight unless otherwise specified.

In the following experiments, a TCM passivation test protocol was employed to study the effect of thymol as a passivation reagent. Preg-rob analysis on test residue was compared against preg-rob from the head analysis. This helped to understand the strength of the TCM. A series of thymol TCM passivation test were conducted on each of the four samples. In this testing method, thymol (C₁₀H₁₄Q, 2-Isopropyl-5-methylphenol) was used to passivate preg-robbing TCM present in the samples. A standard gold spike preg-rob test was conducted after the thymol pretreatment to assess the preg-robbing strength of TCM in the pretreated sample.

The 50-gram sample aliquots used for the test procedure were pulverized to >95%-106 μm. Each sample was placed into a 1 L N algene bottle. Tap water was added to the prepared feed to achieve 25% solids (by weight). Natural pulp pH was measured. Hydrated lime was added to adjust the pH of the pulp to 10.0 before adding the thymol. Thymol equivalent to 1 g Thymol/L solution was added to the slurry.

The slurry was rolled in a bottle on the laboratory rolls for 24 hours. After 24 hours the pulp was filtered to separate liquids and solids. The solution was discarded.

Solids were dried, weighed, and subjected to a standard preg-rob assay procedure (cyanide shake analyses with and without gold spike).

The standard procedure employed a 1 g Thymol/L addition. Tests using this concentration were called “standard” TCM passivation tests. The thymol to TCM ratio was calculated for each test. The thymol to TCM ratio was varied during additional tests on select samples to understand the effect of higher or lower thymol additions on the preg-rob nature of the ore. The ratio was varied by varying the thymol concentration in the pretreatment solution.

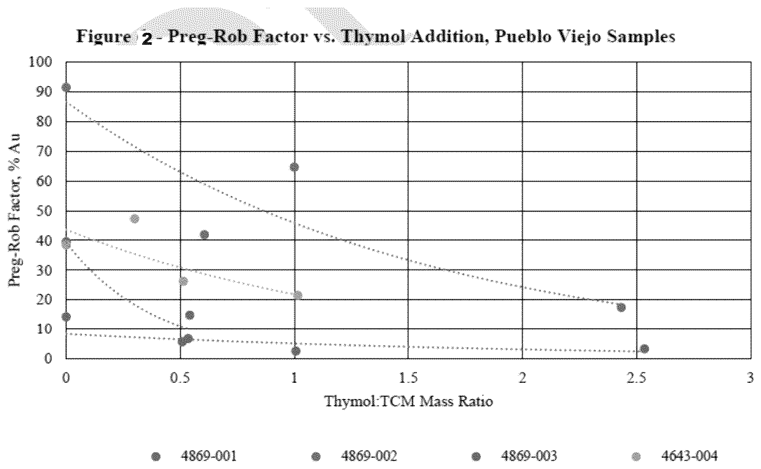

The results from the Thymol test are presented in Table 1 and FIG. 2.

TABLE 1
Thymol Pretreatment/Preg-Rob Analysis Results

| | | | | | | | |
|---|---|---|---|---|---|---|---|
| | | | | AU | | Au PR | |
| | Thymol | AuPR | AuCN | Difference | Au Spike | Value | |
| Thymol: | Cone., | oz/ton | oz/ton | oz/ton | oz/ton | oz/ton | Preg-Rob |
| TCM Ratio | g/L | ore | ore | ore | ore | ore | Factor, % |

CMP-MO12-1329-230 (4869-001) 1.47 gAu/mt. 0.56% TCM

| | | | | | | | |
|---|---|---|---|---|---|---|---|
| Baseline¹⁾ | 0.0 | 0.062 | 0.005 | 0.058 | 0.098 | 0.041 | 39.5 |
| 0.53 | 1.00²⁾ | 0.097 | 0.009 | 0.088 | 0.095 | 0.007 | 6.7 |
| 0.54 | 1.00²⁾ | 0.092 | 0.011 | 0.081 | 0.097 | 0.016 | 14.8 |

CMP-MO12-1331-230 (4869-002) 1.30 gAu/mt 0.71% TCM

| | | | | | | | |
|---|---|---|---|---|---|---|---|
| Baseline ¹⁾ | 0.0 | 0.009 | 0.002 | 0.007 | 0.98 | 0.091 | 91.5 |
| 0.26 | 0.6 | 0.061 | 0.008 | 0.053 | 0.097 | 0.044 | 41.9 |
| 0.42 | 1.00²⁾ | 0.035 | 0.004 | 0.031 | 0.095 | 0.064 | 64.6 |
| 1.03 | 2.4 | 0.090 | 0.012 | 0.078 | 0.097 | 0.019 | 17.4 |

CMP-MO14-0408-140 (4869-003) 4.87 gAu/mt. 0.30% TCM

| | | | | | | | |
|---|---|---|---|---|---|---|---|
| Baseline¹⁾ | 0.0 | 0.099 | 0.18 | 0.082 | 0.098 | 0.017 | 14.3 |
| 0.51 | 0.5 | 0.117 | 0.027 | 0.090 | 0.097 | 0.007 | 5.6 |
| 1.01 | 1.00²⁾ | 0.116 | 0.024 | 0.092 | 0.095 | 0.003 | 2.5 |
| 2.53 | 2.5 | 0.118 | 0.025 | 0.093 | 0.097 | 0.004 | 3.3 |

CMP-MO14-0408-160 (4869-004) 4.42 gAu/mt. 1.00 TCM

| | | | | | | | |
|---|---|---|---|---|---|---|---|
| Baseline¹⁾ | 0.0 | 0.068 | 0.013 | 0.056 | 0.098 | 0.043 | 38.5 |
| 0.30 | 1.00²⁾ | 0.058 | 0.015 | 0.043 | 0.095 | 0.052 | 47.3 |
| 0.51 | 1.7 | 0.090 | 0.025 | 0.065 | 0.097 | 0.032 | 26.2 |
| 1.02 | 3.4 | 0.095 | 0.024 | 0.071 | 0.097 | 0.026 | 21.5 |

Thymol masking test results were inconsistent, but showed significant mitigation of preg-robbing character with thymol pretreatment particularly for the most highly preg-robbing sample (4869-002). Subsequent testing on samples from other projects has shown more effective preg-rob mitigation and more consistent test results when a caustic based solution is used for dissolving the thymol prior to pretreatment. Further testing would be required to confirm that effect on the tested samples.

Preg-rob mitigation testing was conducted on 17 TCM (“total carbonaceous” matter i.e. non-carbonate carbon) containing samples from four properties. The testing was conducted to evaluate the effectiveness of a methylphenol reagent (thymol) for “blinding” the preg-robbing TCM naturally occurring in the samples.

Ore samples tested contained between 0.002 and 0.837 ozAu/ton (0.337 ozAu/ton average) and lower concentrations of silver (0.07 ozAg/ton average). The samples were refractory to cyanide leaching and the ratio of cyanide soluble gold content to the assayed head grade (CN/FA) ranged from 0% to 19.5%. Most of the samples displayed a significant preg-rob character as indicated by preg-rob assay results. The preg-rob factors were above 10% for all but 3 of the samples, and averaged 56.3%. TCM (non-carbonate carbon) content of the samples ranged from 0.05% to 2.77% and averaged 0.79%.

Three series of tests were conducted to evaluate the effectiveness of thymol for blinding the TCM to mitigate the preg-robbing character of the samples. Preg-robbing character was measured by routine preg-rob assays conducted on pre-treated ore samples. Tests were conducted on small aliquots of pulverized (assay pulp) feed. Pre-treatment was conducted by contacting the ore in an aqueous slurry for 24 hours with a range of thymol doses in both basic and acidic pH ranges.

Test results showed that thymol was effective in significantly reducing the preg-robbing factor for most of the moderately to highly preg-robbing samples, over a range of thymol doses. Those doses generally were expressed as the mass ratio of thymol added to TCM naturally occurring in the samples. In general, samples were tested with thymol:TCM mass ratios ranging from 0.05:1 to 1.0:1. Those doses generally were equivalent to between 0.1 to 4.0 g/L thymol or 0.5 to 8.0 lb/ton ore thymol. Test results also indicated that dissolving the thymol in a caustic soda solution before using for pre-treatment was important for maximizing mitigation of the preg-rob character of the samples.

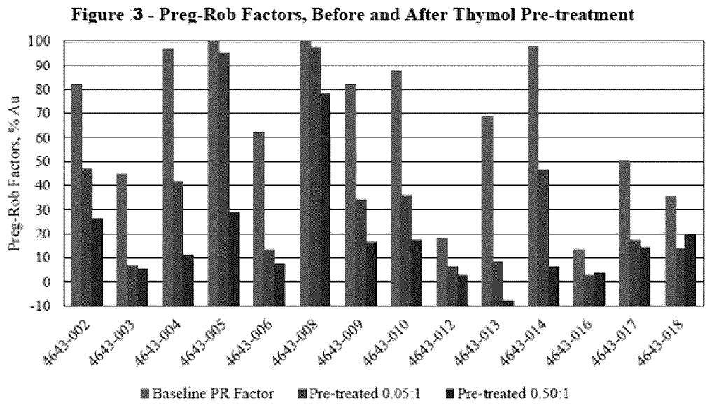

A summary of the test results obtained under conditions evaluated for the 14 of 17samples which had preg-rob factors >10% is presented in FIG. 3. This figure shows the natural preg-rob factor and the preg-rob factor with pre-treatment, using thymol:TCM ratios of 0.5:1 and 0.05:1. Preg-rob factors were substantially reduced for all highly preg-robbing samples, except 4643-008.

TCM blinding tests were conducted on a total of 17 ore samples from four NGM properties. The purpose for these tests was to evaluate the effectiveness of thymol as a TCM passivating agent, and to assess the preg-robbing character of the 17 samples, as part of a larger TCM characterization testing program.

A total of three series of tests were conducted. General procedures were similar for each series, though testing conditions and some procedural details were varied between test series. In general, an organic reagent known to blind TCM (thymol) was used to treat preg-robbing TCM present in the samples. A standard gold spike preg-rob test was conducted after the TCM blinding pre-treatment to assess the preg-robbing strength of TCM in the pre-treated sample.

General testing procedures included contacting a small aliquot of ore (10-50 g/test) in a slurry (25% solids by weight) for 24 hours with a known dose of thymol. The ore used for all tests was from pulverized assay pulps (>90%-106 μm). Tap water was added to reach 25% solids. Thymol was added to the slurry. The slurry, with thymol added, was mixed by rolling in a 1 L Nalgene bottle on laboratory rolls for 24 hours. After pre-treatment, the slurry was filtered and the resulting solids were used for a routine “preg-rob” assay. The preg-rob assay procedure consisted of contacting the pre-treated solids with a “gold-spiked” alkaline cyanide solution for 1 hour.

The resulting pregnant solution was recovered and analyzed for gold content. In general, these results were compared to a routine cyanide shake analysis, conducted on the pre-treated solids, using the same conditions. In the case of Series 1, the pre-treated solids were split in half for the two cyanide shake analyses (with and without “gold-spike). In the case of Series 2, the pre-treatment tests were conducted in duplicate, to generate two separate solids samples for cyanide shake analysis (with and without gold-spike). In the case of Series 3, only a gold-spike cyanide shake was conducted.

### Series 1

All Series 1 tests were conducted using 50 gram aliquots of head assay pulp. Lime was added for pH control during pre-treatment, with a target pre-treatment pH of 10.0. Thymol was added to each slurry as a solid reagent. Slurry density was adjusted to 25% solids.

The slurry was rolled in a bottle on the laboratory rolls for 24 hours. After 24 hours, the pulp was filtered to separate liquids and solids. The solution was discarded. Solids were dried, weighed, and split in half to obtain two sample aliquots for the required cyanide shake analyses. Those two splits were used for a standard preg-rob assay procedure (cyanide shake analyses with and without gold spike).

Initially, each of the 17 samples was tested using a pre-treatment thymol concentration equivalent to 1.0 g/L. Subsequent Series 1 testing included evaluation of varied thymol additions and replicate testing, to better understand variability in results. During these follow-up tests, the thymol dose was set relative to the TCM content of the individual samples (thymol:TCM mass ratio). Evaluation of Thymol:TCM mass ratios of 0.5:1 and 1.0:1 was included for most of the samples tested.

### Series 2

Series 2 testing was conducted only on the 14 samples with a baseline preg-rob factor of >10%. The quantity of solids used for these tests was decreased to 10 grams. Tests were conducted in duplicate to generate samples for the two cyanide shake analyses (with and without gold-spike). The thymol reagent used for these tests was first dissolved in a 5 g/L NaOH solution, at a thymol concentration of 10 g/L. Solution make-up was determined during a thymol solubility test (described in the Appendix), Caustic, equivalent to 5 g/L NaOH was also added to the pre-treatment slurries to maintain pre-treatment pH, for all Series 2 tests. Evaluation of Thymol:TCM mass ratios of 0.05:1 and 0.50:1 was included for most of the samples tested.

### Series 3

Series 3 testing was conducted on three select samples (4643-006, 009 and 010). The thymol reagent used for all of the Series 3 tests was prepared in the same manner as for Series 2 (10 g/L thymol and 5 g/L NaOH). Unlike Series 2, the Series 3 tests did not necessarily have caustic added otherwise to the pre-treatment slurry. Tests were conducted without pH control during pre-treatment, using caustic added at 0.2, 1.0 and 5.0 g/L NaOH during pre-treatment and using hydrated lime to maintain pH 8.0 and 10.5 during pre-treatment. The tests without pH control and the tests using lime to maintain pH 10.5 were run in duplicate (total of 8 tests/sample). All Phase 3 tests were conducted using at thymol:TCM mass ratio of 0.5:1.

In order to decrease the number of tests required for the Phase 3 evaluation, each set of test conditions was evaluated using a single 10 gram aliquot of ore. The pre-treated solids from each test were used for the gold-spiked cyanide shake analysis. A correlation between the spiked preg-rob test results and the preg-rob factor was developed for each of the three samples during Phase 1 and 2 testing. Those correlations were used to estimate the preg-rob factor for each the Phase 3 tests using only the spiked preg-rob test results.

### Test Results

Preg-rob passivation testing and associated testing results are presented as follows:

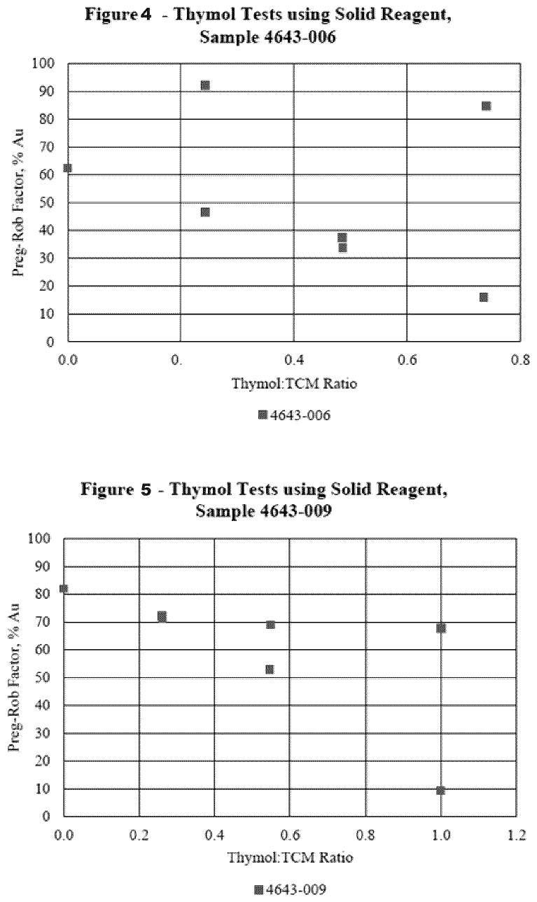

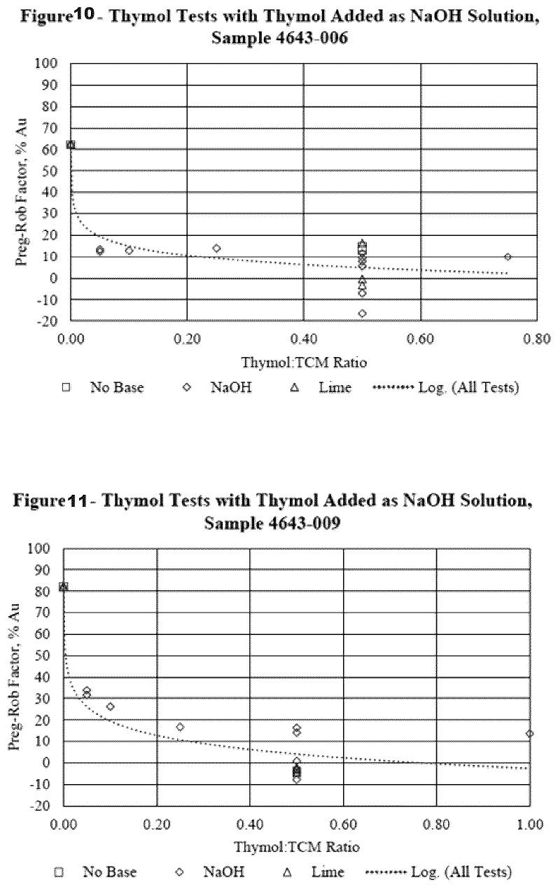

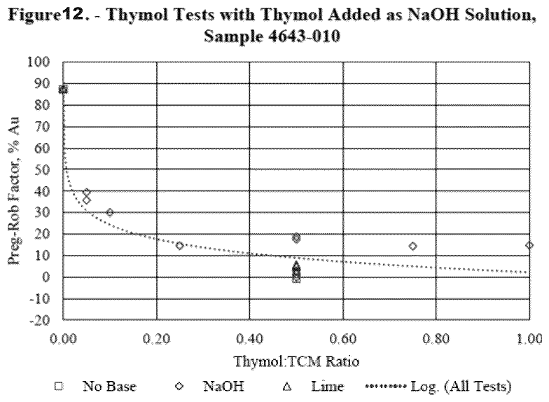

Preg-Rob Passivation Testing

| | |
|---|---|
| Series 1 Passivation Test Results, FM, GR and LV Samples | Table 1 |
| Series 1 Passivation Test Results, TR Samples | Table 2 |
| Series 1 Preg-Rob Factor vs Thymol:TCM Ratio, | FIGS. 2-4 |
| Select Samples (4643-006, 009 and 010) | |
| Series 1 Test Data and Figures, All Samples | Sect. 2, App. |
| Series 2 Passivation Test Results, FM, GR and LV Samples | Table 3 |
| Series 2 Passivation Test Results, TR Samples | Table 4 |
| Series 2 Preg-Rob Factor vs Thymol:TCM Ratio, | FIGS. 5-7 |
| Select Samples (4643-006, 009 and 010) | |
| Series 2 Test Data and Figures, All Samples | Sect. 3, App. |
| Series 3 Passivation Test Results, LV and TR Samples | Table 5 |
| Series 3 Preg-Rob Factor vs Thymol:TCM Ratio, | FIGS. 8-10 |
| Select Samples (4643-006, 009 and 010) | |
| Series 3 Test Data and Figures, All Samples | Sect. 4, App. |

TABLE 3
Summary Results, Thymol Passivation Tests (Series 1), FM, GR and LV Preg-Robbing Ore Samples

| | | TCM, | | Thymol:TCM | Thymol, | Pre-treat | Preg-Rob |
|---|---|---|---|---|---|---|---|
| Sample | Project | % | Test | Mass Ratio | g/L | pH, stu | %, Au |
| 4643-003 | FM | 0.31 | Baseline | | N/A | N/A | 44.7 |
| | | | PR-12 | 0.27 | 0.28 | N/A | 17.0 |
| | | | PR-15 | 0.44 | 0.45 | N/A | 1.2 |
| | | | PR-5 | 0.94 | 0.97 | N/A | 5.6 |
| | | | PR-8 | 0.97 | 1.00 | N/A | 11.0 |
| 4643-004 | GR | 0.66 | Baseline | | N/A | N/A | 96.5 |
| | | | PR-532 | 0.27 | 0.58 | 10.2 | 84.3 |
| | | | PR-533 | 0.27 | 0.58 | 10.4 | 57.3 |
| | | | PR-13 | 0.27 | 0.59 | N/A | 89.6 |
| | | | PR-404 | 0.27 | 0.59 | 12.5 | 72.9 |
| | | | PR-400 | 0.45 | 1.00 | N/A | 41.4 |
| | | | PR-16 | 0.45 | 1.00 | N/A | 47.1 |
| | | | PR-6 | 0.46 | 1.00 | N/A | 69.5 |
| | | | PR-531 | 0.55 | 1.20 | 10.4 | 67.8 |
| | | | PR-530 | 0.97 | 2.13 | 10.4 | 49.6 |
| | | | PR-401 | 0.97 | 2.13 | N/A | 12.8 |
| | | | PR-18 | 0.97 | 2.13 | N/A | 19.2 |
| | | | PR-11 | 0.97 | 2.13 | N/A | 65.5 |
| | | | PR-403 | 0.97 | 2.13 | 12.5 | 47.7 |
| 4643-005 | LV | 2.77 | Baseline | | N/A | N/A | 71.1 |
| | | | PR-501 | 0.11 | 0.97 | 10.4 | 99.0 |
| | | | PR-536 | 0.11 | 0.97 | 10.1 | 98.0 |
| | | | PR-515 | 0.52 | 4.76 | 10.2 | 71.1 |
| | | | PR-535 | 0.52 | 4.76 | 10.0 | 47.2 |
| | | | PR-515R | 0.52 | 4.77 | 10.1 | 50.0 |
| | | | PR-516R | 1.02 | 9.46 | 10.2 | 33.6 |
| | | | PR-534 | 1.03 | 9.49 | 10.3 | 56.3 |
| | | | PR-516 | 1.03 | 9.50 | 10.3 | 100.0 |
| 4643-006 | LV | 0.63 | Baseline | | N/A | N/A | 62.4 |
| | | | PR-539 | 0.24 | 0.51 | 10.0 | 46.7 |
| | | | PR-517 | 0.24 | 0.51 | 10.2 | 92.2 |
| | | | PR-502 | 0.49 | 1.01 | 10.2 | 37.4 |
| | | | PR-538 | 0.49 | 1.01 | 10.1 | 33.8 |
| | | | PR-537 | 0.73 | 1.53 | 10.0 | 16.0 |
| | | | PR-518 | 0.74 | 1.54 | 10.2 | 84.8 |
| 4643-007 | LV | 0.23 | Baseline | | N/A | N/A | 2.9 |
| | | | PR-503 | 1.33 | 1.00 | 10.2 | 2.3 |
| 4643-008 | LV | 0.54 | Baseline | | N/A | N/A | 100.0 |
| | | | PR-542 | 0.56 | 1.01 | 10.2 | 96.9 |
| | | | PR-504 | 0.57 | 1.02 | 10.1 | 97.0 |
| | | | PR-541 | 0.98 | 1.77 | 10.3 | 92.8 |
| | | | PR-519 | 0.99 | 1.78 | 10.2 | 97.9 |
| | | | PR-540 | 1.99 | 3.59 | 10.1 | 67.0 |
| 4643-002 | TR | 1.12 | Baseline | | N/A | N/A | 82.0 |
| | | | PR-7 | 0.27 | 1.00 | N/A | 86.7 |
| | | | PR-4 | 0.27 | 1.02 | N/A | 81.6 |
| | | | PR-14 | 0.46 | 1.70 | N/A | 20.5 |
| | | | PR-10 | 0.97 | 3.61 | N/A | 9.6 |
| | | | PR-17 | 0.97 | 3.61 | N/A | 5.3 |
| 4643-009 | TR | 0.55 | Baseline | | N/A | N/A | 81.9 |
| | | | PR-545 | 0.26 | 0.47 | 10.4 | 72.2 |
| | | | PR-520 | 0.26 | 0.48 | 10.2 | 71.3 |
| | | | PR-505 | 0.55 | 0.90 | 10.1 | 52.9 |
| | | | PR-544 | 0.55 | 1.00 | 10.3 | 69.0 |
| | | | PR-543 | 1.00 | 1.82 | 10.1 | 9.3 |
| | | | PR-521 | 1.00 | 1.82 | 10.0 | 67.6 |
| 4643-010 | TR | 0.77 | Baseline | | N/A | N/A | 87.4 |
| | | | PR-548 | 0.25 | 0.64 | 10.1 | 93.8 |
| | | | PR-522 | 0.25 | 0.64 | 10.0 | 43.6 |
| | | | PR-506 | 0.39 | 1.01 | 9.9 | 66.0 |
| | | | PR-547 | 0.40 | 1.02 | 10.1 | 89.7 |
| | | | PR-523 | 0.74 | 1.90 | 10.0 | 11.8 |
| | | | PR-546 | 0.74 | 1.90 | 10.0 | 45.7 |
| 4643-011 | TR | 1.13 | Baseline | | N/A | N/A | 5.6 |
| | | | PR-507 | 0.27 | 1.02 | N/A | 5.3 |
| 4643-012 | TR | 1.14 | Baseline | | N/A | NA | 18.3 |
| | | | PR-524 | 0.10 | 0.37 | 10.1 | 7.7 |
| | | | PR-508 | 0.26 | 0.99 | 11.3 | 4.9 |
| 4643-013 | ITR | 1.38 | Baseline | | N/A | N/A | 68.6 |
| | | | PR-525 | 0.10 | 0.44 | 10.1 | 10.8 |
| | | | PR-551 | 0.10 | 0.46 | 10.2 | 30.4 |
| | | | PR-509 | 0.22 | 0.99 | 10.3 | 8.4 |
| | | | PR-550 | 0.22 | 1.00 | 10.2 | 18.7 |
| | | | PR-549 | 0.50 | 2.29 | 10.3 | 7.3 |
| 4643-014 | TR | 0.51 | Baseline | | N/A | N/A | 98.0 |
| | | | PR-526 | 0.25 | 0.42 | 10.4 | 43.4 |
| | | | PR-554 | 0.25 | 0.42 | 10.3 | 85.1 |
| | | | PR-553 | 0.59 | 0.99 | 10.1 | 69.2 |
| | | | PR-510 | 0.60 | 1.00 | 10.0 | 47.7 |
| | | | PR-552 | 1.00 | 1.68 | 10.5 | 13.6 |
| | | | PR-527 | 1.00 | 1.68 | 10.1 | 2.7 |
| 4643-015 | TR | 0.05 | Baseline | | N/A | N/A | 19.3 |
| | | | PR-511 | 6.67 | 1.00 | 10.5 | 0.9 |
| 4643-016 | TR | 0.05 | Baseline | | N/A | N/A | 13.4 |
| | | | PR-512 | 5.97 | 1.00 | 10.2 | 1.5 |
| 4643-017 | TR | 0.75 | Baseline | | N/A | N/A | 50.5 |
| | | | PR-528 | 0.25 | 0.62 | 10.0 | 9.2 |
| | | | PR-513 | 0.40 | 1.00 | 11.0 | 6.7 |
| 4643-018 | TR | 0.83 | Baseline | | N/A | N/A | 35.2 |
| | | | PR-529 | 0.10 | 0.28 | 10.3 | 9.1 |
| | | | PR-514 | 0.36 | 0.99 | 10.6 | 8.0 |

### Table 4.-Summary Results, Thymol Passivation Tests (Series 1), TR Preg-Robbing Ore Samples

Results from Phase 1 testing (Ref. Tables 2 and 3) showed that pre-treatment of the preg-robbing ores with thymol generally resulted in a substantial reduction in the preg-rob factor. Results tended to be highly variable though, and repeatability under the same thymol dose was poor.

Results are presented graphically for three select samples (4643-006, 009 and 010) in FIGS. 3 through 5. Data from these samples are presented here as they are fairly representative of the results obtained from the other moderately to highly preg-robbing ores tested and because these three samples were selected for more extensive testing during subsequent phases,

As shown graphically for sample 4643-006, a reduction in the preg-rob factor from 62.4% without pre-treatment to as low as 16.0% after pre-treatment with a thymol dose equivalent to a thymol:TCM mass ratio of 0.73:1. Results were erratic however, as shown graphically. Similar results were seen for samples 4643-009 and 010. Substantial reductions in the preg-rob factor were achieved, but results were erratic.

TABLE 4
Summary Results, Thymol Passivation Tests (Series 2), FM, GR and LV Preg-Robbing Ore Samples

| | | TCM, | | Thymol:TCM | Thymol, | Pre-treat | Preg-Rob |
|---|---|---|---|---|---|---|---|
| Sample | Project | % | Test | Mass Ratio | g/L | pH, stu | %, Au |
| 4643-003 | FM | 0.31 | Baseline | | N/A | N/A | 44.7 |
| | | | TH-014 | 0.05 | 0.08 | N/A | 6.6 |
| | | | TH-015 | 0.50 | 0.78 | N/A | 5.5 |
| 4643-004 | GR | 0.66 | Baseline | | N/A | N/A | 96.5 |
| | | | TH-016 | 0.05 | 0.17 | N/A | 41.9 |
| | | | TH-017 | 0.50 | 1.65 | N/A | 11.1 |
| 4643-005 | LV | 2.77 | Baseline | | N/A | N/A | 71.1 |
| | | | TH-018 | 0.05 | 0.69 | N/A | 95.3 |
| | | | TH-019 | 0.50 | 6.93 | N/A | 29.0 |
| 4643-006 | LV | 0.63 | Baseline | | N/A | N/A | 62.4 |
| | | | TH-004-1 | 0.05 | 0.15 | N/A | 12.5 |
| | | | TH-020 | 0.05 | 0.16 | N/A | 13.5 |
| | | | TH-001-1 | 0.10 | 0.30 | N/A | 12.9 |
| | | | TH-001 | 0.75 | 2.34 | N/A | 9.9 |
| 4643-008 | LV | 0.54 | Baseline | | N/A | N/A | 100.0 |
| | | | TH-022 | 0.05 | 0.14 | N/A | 97.6 |
| | | | TH-023 | 0.50 | 1.35 | N/A | 78.3 |

TABLE 5
Summary Results, Thymol Passivation Tests (Series 2), TR Preg-Robbing Ore Samples

| | | TCM, | | Thymol:TCM | Thymol, | Pre-treat | Preg-Rog |
|---|---|---|---|---|---|---|---|
| Sample | Project | % | Test | Mass Ratio | g/L | pH, stu | %, Au |
| 4643-002 | TR | 1.12 | Baseline | | N/A | N/A | 82.0 |
| | | | TH-012 | 0.05 | 0.28 | N/A | 46.8 |
| | | | TH-013 | 0.50 | 2.80 | N/A | 26.1 |
| 4643-009 | TR | 0.55 | Baseline | | N/A | N/A | 81.9 |
| | | | TH-024 | 0.05 | 0.14 | N/A | 33.9 |
| | | | TH-007-1 | 0.05 | 0.15 | N/A | 31.6 |
| | | | TH-005-1 | 0.10 | 0.30 | N/A | 26.2 |
| | | | TH-007 | 0.25 | 0.68 | N/A | 16.8 |
| | | | TH-006 | 0.50 | 1.36 | N/A | 14.2 |
| | | | TH-025 | 0.50 | 1.38 | N/A | 16.5 |
| | | | TH-005 | 1.00 | 2.73 | N/A | 13.8 |
| 4643-010 | TR | 0.77 | Baseline | | N/A | N/A | 87.4 |
| | | | TH-026 | 0.05 | 0.19 | N/A | 35.8 |
| | | | TH-011-1 | 0.05 | 0.20 | N/A | 39.5 |
| | | | TH-008-1 | 0.10 | 0.40 | N/A | 30.1 |
| | | | TH-011 | 0.25 | 0.96 | N/A | 14.5 |
| | | | TH-010 | 0.50 | 1.93 | N/A | 18.8 |
| | | | TH-027 | 0.50 | 1.93 | N/A | 17.5 |
| | | | TH-009 | 0.75 | 2.89 | N/A | 14.4 |
| | | | TH-008 | 1.00 | 3.85 | N/A | 14.8 |
| 4643-012 | TR | 1.14 | Baseline | | N/A | N/A | 18.3 |
| | | | TH-028 | 0.05 | 0.29 | N/A | 6.2 |
| | | | TH-029 | 0.50 | 2.85 | N/A | 2.8 |
| 4643-013 | TR | 1.38 | Baseline | | N/A | N/A | 68.6 |
| | | | TH-030 | 0.05 | 0.35 | N/A | 8.1 |
| | | | TH-031 | 0.50 | 3.45 | N/A | −8.0 |
| 4643-014 | TR | 0.51 | Baseline | | N/A | N/A | 98.0 |
| | | | TH-032 | 0.05 | 0.13 | N/A | 46.4 |
| | | | TH-033 | 0.50 | 1.28 | N/A | 6.0 |
| 4643-016 | TR | 0.05 | Baseline | | N/A | N/A | 13.4 |
| | | | TH-034 | 0.05 | 0.01 | N/A | 2.9 |
| | | | TH-035 | 0.50 | 0.13 | N/A | 3.7 |
| 4643-017 | TR | 0.75 | Baseline | | N/A | N/A | 50.5 |
| | | | TH-036 | 0.05 | 0.19 | N/A | 17.1 |
| | | | TH-037 | 0.50 | 1.88 | N/A | 14.3 |
| 4643-018 | TR | 0.83 | Baseline | | N/A | N/A | 35.2 |
| | | | TH-038 | 0.05 | 0.21 | N/A | 13.9 |
| | | | TH-039 | 0.50 | 2.08 | N/A | 20.0 |

Results from Phase 2 testing (Ref. Tables 4 and 5) showed that dissolving the thymol reagent in a caustic solution (5 g/L NaOH and 10 g/L thymol) along with adjusting pre-treatment slurry pH using caustic (5 g/L NaOH) resulted in more effective and much more consistent mitigation of preg-robbing for the samples tested.

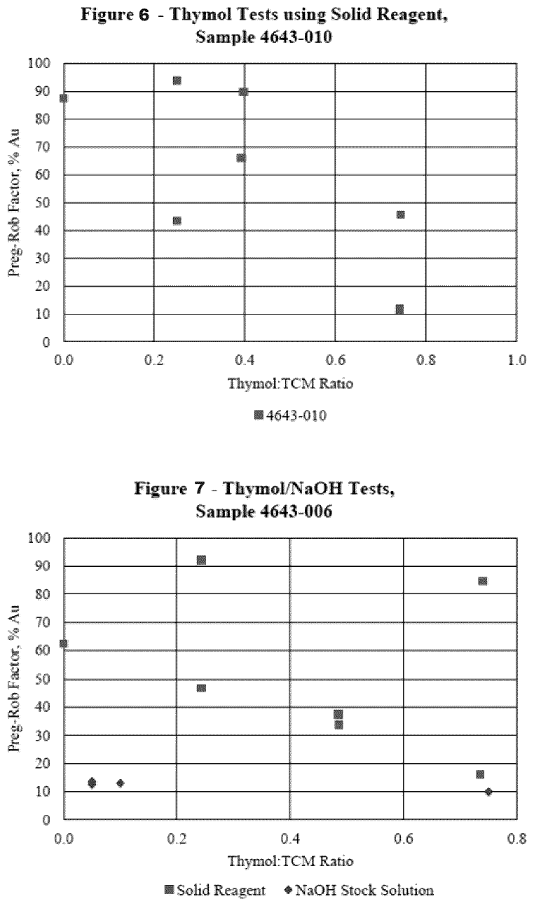

Again, results from the same three select samples are shown graphically here (Ref. FIGS. 6 through 8) and were representative of results obtained from the other moderately to strongly preg-robbing samples. Phase 1 testing results were included in these figures for comparison to the Phase 2 results (noted as “NaOH stock solution” in the figures). A relatively low thymol dose, equivalent to a thymol:TCM ratio of 0.05:1 was effective in decreasing the preg-rob factor from sample 4643-006 from about 62% to 13%. Similar preg-rob factors were observed with this sample at higher thymol doses. Results were much more consistent than obtained during Phase 1 testing. Phase 2 results obtained from samples 4643-009 and 4643-010 also showed a substantial reduction in the preg-rob factor at relatively low thymol doses and good test reproducibility where replicate tests were conducted.

TABLE 6
Summary Results, Thymol Passivation Tests (Series 3), LV and TR Preg-Robbing Ore Samples

| | | | | | | | Lime | | |
|---|---|---|---|---|---|---|---|---|---|
| | | TCM, | | Thymol:TCM | Thymol, | NaOH, | Target | Pre-treat | Preg-Rob |
| Sample | Project | % | Test | Mass Ratio | g/L | g/L | pH | pH, stu | %, Au |
| 4643-006 | LV | 0.63 | Baseline | | N/A | N/A | N/A | N/A | 62.4 |
| | | | TH-040 | 0.50 | 1.58 | 0.0 | N/A | 7.8 | 13.2 |
| | | | TH-041 | 0.50 | 1.58 | 0.0 | N/A | 7.7 | 14.7 |
| | | | TH-044 | 0.50 | 1.58 | 0.2 | N/A | 8.3 | 11.6 |
| | | | TH-043 | 0.50 | 1.58 | 1.0 | N/A | 9.5 | −7.0 |
| | | | TH-042 | 0.50 | 1.58 | 5.0 | N/A | 12.2 | −16.6 |
| | | | TH-045 | 0.50 | 1.58 | N/A | 8.0 | 8.0 | 16.3 |
| | | | TH-046 | 0.50 | 1.58 | N/A | 10.5 | 9.7 | −0.5 |
| | | | TH-047 | 0.50 | 1.58 | N/A | 10.5 | 10.0 | −3.2 |
| 4643-009 | TR | 0.55 | Baseline | | N/A | N/A | N/A | N/A | 81.9 |
| | | | TH-048 | 0.50 | 1.38 | 0.0 | N/A | 8.0 | −3.8 |
| | | | TH-049 | 0.50 | 1.38 | 0.0 | N/A | 7.9 | −4.6 |
| | | | TH-052 | 0.50 | 1.38 | 0.2 | N/A | 8.4 | −3.0 |
| | | | TH-051 | 0.50 | 1.38 | 1.0 | N/A | 9.7 | −7.7 |
| | | | TH-050 | 0.50 | 1.38 | 5.0 | N/A | 12.4 | 0.9 |
| | | | TH-053 | 0.50 | 1.38 | N/A | 8.0 | 8.2 | −3.0 |
| | | | TH-054 | 0.50 | 1.38 | N/A | 10.5 | 9.0 | −2.2 |
| | | | TH-055 | 0.50 | 1.38 | N/A | 10.5 | 8.4 | −4.6 |
| 4643-010 | TR | 0.77 | Baseline | | N/A | N/A | N/A | N/A | 87.4 |
| | | | TH-056 | 0.50 | 1.93 | 0.0 | N/A | 8.1 | −0.9 |
| | | | TH-057 | 0.50 | 1.93 | 0.0 | N/A | 8.1 | −0.9 |
| | | | TH-060 | 0.50 | 1.93 | 0.2 | N/A | 8.3 | 2.8 |
| | | | TH-059 | 0.50 | 1.93 | 1.0 | N/A | 8.6 | 1.3 |
| | | | TH-058 | 0.50 | 1.93 | 5.0 | N/A | 11.8 | −0.2 |
| | | | TH-061 | 0.50 | 1.93 | N/A | 8.0 | 8.2 | 2.8 |
| | | | TH-062 | 0.50 | 1.93 | N/A | 10.5 | 8.6 | 5.0 |
| | | | TH-063 | 0.50 | 1.93 | N/A | 10.5 | 8.5 | 5.7 |

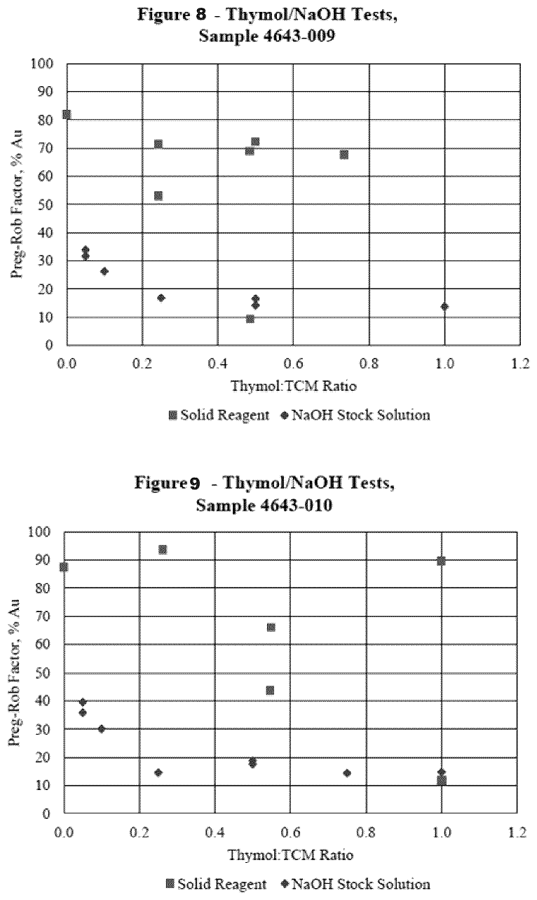

Results from Phase 3 testing demonstrated that, provided the thymol reagent used for pre-treatment was first dissolved in a caustic solution, the method used for pH control during pre-treatment did not have an effect on preg-rob mitigation. As shown in FIGS. 9 through 11, tests with no pH control (“no base”) and using lime for pH control gave similar results to the tests with NaOH added during pre-treatment. Phase 2 test results were included in FIGS. 9 through 11, for comparison. All of the tests shown were conducted with the thymol reagent dissolved in a caustic soda solution before use. As noted earlier, the Phase 3 preg-rob factors were estimated, using correlations established earlier, based on only the spiked cyanide shake analysis results. Consequently, the Phase 3 results should be considered qualitative, but useful for comparison between the conditions evaluated during Phase 3 testing.

### CONCLUSIONS

The following conclusions were drawn from the various tests:
Pre-treatment of preg-robbing ores using thymol reagent was effective in substantially mitigating the preg-robbing character for most of the TCM samples tested. Scoping thymol pre-treatment test results showed that preg-rob factors were reduced to an average of 3.1% by pre-treating with thymol to a TCM mass ratio of 0.5:1. More specifically, preg-rob factors for a number of samples were substantially reduced at a thymol:TCM ratio of about 0.05:1 and almost completely mitigated at a 0.5:1 thymol:TCM ratio.
Dissolving the thymol reagent in a caustic solution before using was important for maximizing the preg-rob mitigation and obtaining reproducible results.
Slurry pH adjustment during pre-treatment with thymol was not necessary for achieving preg-rob mitigation using thymol, provided the thymol reagent was first dissolved in a caustic soda solution. Effective preg-rob mitigation was observed by pre-treatment in both acidic and basic slurries.
The presence of lime in the pre-treatment slurry did not have an adverse effect on preg-rob mitigation, provided the thymol reagent was first dissolved in a caustic soda solution.
Cyanidation testing results demonstrated that the thymol pre-treatment procedure was roughly as effective as adding granular activated carbon (GAC) during leaching for mitigating preg-robbing. Test grades from the thymol tests were similar to or slightly lower than tail grades from baseline testing, supporting the conclusion that the thymol pre-treatment was as effective as adding GAC during leaching. Gold recoveries for cyanidation (in the absence of GAC) after thymol pre-treatment were nearly the same or slightly higher than recoveries from baseline carbon-in-leach (CIL) tests (in the absence of thymol pre-treatment).
Results further established that thymol pre-treatment did not significantly inhibit gold loading on GAC.
Results further indicate that HCN or cyanide consumption from leaching gold from a given gold-bearing TCM sample under common leaching conditions (e.g., residence time, temperature, pH, dissolved oxygen content, etc.), in the absence of thymol pre-treatment and with or without GAC addition, was more than cyanide consumption for the same gold-bearing TCM sample after thymol pre-treatment. Typically, thymol pre-treatment reduces cyanide consumption by at least about 5 vol. %, more typically by at least about 10 vol. %, more typically by at least about 15 vol. %, more typically by at least about 20 vol. %, and even more typically by at least about 25 vol. %.

A number of variations and modifications of the disclosure can be used. It would be possible to provide for some features of the disclosure without providing others. The present disclosure, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process comprising:
leaching a precious metal from a precious metal-containing material comprising a preg-robbing material in the presence of a blanking agent comprising one or more of a methylphenol and phenolate salt thereof to form a pregnant leach solution comprising the precious metal; and
recovering at least most of the precious metal from the pregnant leach solution.

2. The process of claim 1, wherein the blanking agent comprises 2-isopropyl-5-methylphenol and wherein the leaching comprises contact a cyanide-containing lixiviant with the precious metal-containing material.

3. The process of claim 1, wherein the blanking agent comprises carvacrol and wherein the leaching comprises contacting a cyanide-containing lixiviant with the precious metal-containing material.

4. The process of claim 1, wherein, during leaching, a slurry comprises the precious metal-containing material, leaching solution, and blanking agent, wherein a concentration of the precious metal-containing material in the slurry ranges from about 15 to about 50% solids, and wherein the blanking agent comprises a phenolate salt and wherein the leaching comprises contacting a cyanide-containing lixiviant with the precious metal-containing material.

5. The process of claim 1, wherein the recovering comprises adsorbing the precious metal onto activated carbon in one or more of a carbon-in-leach (CIL), carbon-in-column (CIC), and carbon-in-pulp (CIP) process.

6. The process of claim 1, wherein the blanking agent has a concentration in the leaching ranging from about 0.1 to about 25 g/L.

7. The process of claim 1, wherein the precious metal in the precious metal-containing material comprises gold.

8. The process of claim 1, wherein the weight ratio of blanking agent to the preg-robbing material ranges from about 0.001:1 to about 10:1.

9. The process of claim 1, wherein a preg-rob factor of the preg-robbing material in the presence of the blanking agent is no more than about 75% of a preg-rob factor of the preg-robbing material in the absence of the blanking agent.

10. The process of claim 1, further comprising:
dissolving the blanking agent in a caustic solution to form a reagent solution; and
thereafter contacting the reagent solution with a leaching solution used in the leaching step.

11. A process comprising:
leaching a precious metal from a precious metal-containing material comprising a preg-robbing material in the presence of a blanking agent to form a pregnant leach solution comprising the precious metal, wherein the blanking agent comprises 2-isopropyl-5-methylphenol and wherein the leaching comprises contacting a cyanide-containing lixiviant with the precious metal-containing material; and
recovering at least most of the precious metal from the pregnant leach solution, wherein a preg-rob factor of the preg-robbing material in the presence of the blanking agent was no more than about 75% of a preg-rob factor of the preg-robbing material in the absence of the blanking agent.

12. The process of claim 11, wherein, during leaching, a slurry comprises the precious metal-containing material, leaching solution, and blanking agent, wherein a concentration of the precious metal-containing material in the slurry ranges from about 15 to about 50% solids, and wherein the recovering comprises adsorbing the precious metal onto activated carbon in one or more of a carbon-in-leach (CIL), carbon-in-column (CIC), and carbon-in-pulp (CIP) process.

13. The process of claim 11, wherein the blanking agent has a concentration in the leaching ranging from about 0.1 to about 25 g/L.

14. The process of claim 11, wherein the precious metal in the precious metal-containing material comprises gold.

15. The process of claim 11, wherein the mass ratio of blanking agent to the preg-robbing material ranges from about 0.001:1 to about 10:1.

16. The process of claim 1, wherein a preg-rob factor of the preg-robbing material in the presence of the blanking agent is no more than about 50% of a preg-rob factor of the preg-robbing material in the absence of the blanking agent.

17. A process comprising:
mixing a blanking agent with a caustic solution to form a reagent-containing solution, the blanking agent comprising one or more of a methylphenol and phenolate salt thereof;
leaching a precious metal from a slurried precious metal-containing material comprising a preg-robbing material in the presence of the reagent-containing solution to form a pregnant leach solution comprising the precious metal, wherein a concentration of the slurried precious metal-containing material in the slurry ranges from about 15 to about 50% solids, and wherein the slurry comprises a cyanide-containing lixiviant; and
recovering at least most of the precious metal from the pregnant leach solution.

18. The process of claim 17, wherein the blanking agent comprises 2-isopropyl-5-methylphenol, and wherein the recovering comprises adsorbing the precious metal onto activated carbon in one or more of a carbon-in-leach (CIL), carbon-in-column (CIC), and carbon-in-pulp (CIP) process.

19. The process of claim 17, wherein the blanking agent comprises carvacrol and wherein the recovering comprises adsorbing the precious metal onto activated carbon in one or more of a carbon-in-leach (CIL), carbon-in-column (CIC), and carbon-in-pulp (CIP) process.

20. The process of claim 17, wherein the blanking agent has a concentration in the leaching ranging from about 0.1 to about 25 g/L, wherein the mass ratio of blanking agent to the preg-robbing material ranges from about 0.001:1 to about 10:1, and wherein a preg-rob factor of the preg-robbing material in the presence of the blanking agent is no more than about 75% of a preg-rob factor of the preg-robbing material in the absence of the blanking agent.
